(19) United States
(12) Patent Application Publication
(10) Pub. No.: US 2024/0412366 A1
(43) Pub. Date: Dec. 12, 2024

(54) DETECTION OF ANOMALIES IN THREE-DIMENSIONAL IMAGES

(71) Applicant: Intel Corporation, Santa Clara, CA (US)

(72) Inventors: Jiaxiang Jiang, Santa Clara, CA (US); Athmanarayanan Lakshmi Narayanan, San Bruno, CA (US); Nilesh Ahuja, Cupertino, CA (US); Ibrahima Jacques Ndiour, Chandler, AZ (US); Ergin Utku Genc, Portland, OR (US); Mahesh Subedar, Portland, OR (US); Omesh Tickoo, Portland, OR (US)

(21) Appl. No.: 18/812,700

(22) Filed: Aug. 22, 2024

(51) Int. Cl. G06T 7/00

(52) U.S. Cl. CPC G06T 7/0012; G06T 2207/20084; G06T 2207/30004

(57) ABSTRACT

Systems, apparatus, articles of manufacture, and methods to detect anomalies in three-dimensional (3D) images are disclosed. Example apparatus disclosed herein generate a first two-dimensional (2D) anomaly map corresponding to a first 2D image slice of a 3D image, the first 2D image slice corresponding to a first axis of the 3D image. Disclosed example apparatus also generate a second 2D anomaly map corresponding to a second 2D image slice of the 3D image, the second 2D image slice corresponding to a second axis of the 3D image. Disclosed example apparatus further generate a 3D anomaly volume based on the first 2D anomaly map and the second 2D anomaly detection, the 3D anomaly volume corresponding to the 3D image.

### BACKGROUND

Anomaly detection involves processing images to identify irregularities that deviate from the image characteristics, such as patterns, colors, shading, etc., exhibited by a training image dataset that does not contain irregularities. Such irregularities are referred to as anomalies, out-of-distribution samples, etc. There are numerous two-dimensional (2D) anomaly detection techniques for detecting anomalies in 2D images. Three-dimensional (3D) anomaly detection techniques have also been developed to detect anomalies in 3D images, also referred to as 3D image volumes, 3D volumes, etc. 3D anomaly detection has many applications. For example, 3D anomaly detection can be used in healthcare applications to detect anomalies in the 3D medical image scans to assist in medical diagnosis, treatment, etc.

### BRIEF DESCRIPTION OF THE DRAWINGS

FIG. 1 is a block diagram of an example environment included an example three-dimensional (3D) anomaly detector circuit to detect anomalies in 3D images in accordance with teachings of this disclosure.

FIG. 2 illustrates example operations performed by the 3D anomaly detector circuit of FIG. 1 to detect an anomaly in an input 3D image.

FIG. 3 illustrates an example two-dimensional (2D) anomaly detection model implemented by the 3D anomaly detector circuit of FIG. 1.

FIGS. 4-6 are flowcharts representative of example machine readable instructions and/or example operations that may be executed, instantiated, and/or performed by example programmable circuitry to implement the 3D anomaly detector circuit 105 of FIG. 1.

FIG. 7 is a block diagram of an example processing platform including programmable circuitry structured to execute, instantiate, and/or perform the example machine readable instructions and/or perform the example operations of FIGS. 4-6 to implement the 3D anomaly detector circuit 105 of FIG. 1.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 4-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

The healthcare industry has benefitted from advancements made in medical imaging techniques. While these advanced imaging techniques can provide detailed three-dimensional (3D) scans of patient organs, they also create increasing workloads for radiologists. Therefore, automated anomaly detection has been pursued as a way to assist doctors and radiologists in diagnosing and predicting disease development based on medical images (scans) and to improve disease treatment and prognosis.

Anomaly detection involves processing images to identify irregularities that deviate from the image characteristics, such as patterns, colors, shading, etc., exhibited by a training image dataset that does not contain irregularities. Such irregularities are referred to as anomalies, out-of-distribution samples, etc. In the medical context, visual anomaly detection is important because visual anomalies can be directly associated with health issues caused by diseases or imaging system malfunctions (e.g., manufacturing defects, faulty calibration, image corruptions, etc.).

Example anomaly detection techniques disclosed herein focus on the problem of anomaly detection for 3D images, such as 3D medical scans. 3D images are also referred to as 3D image volumes, 3D volumes, etc. Example anomaly detection techniques disclosed herein identify abnormal 3D scans (e.g., corresponding to a global anomaly detection) and provide detailed locations (e.g., anatomical locations) of the detected anomalies (e.g., corresponding to local anomaly segmentation).

Example 3D anomaly detection techniques disclosed herein provide efficient unsupervised anomaly detection for 3D images, such as 3D medical scans. For example, at least some of the disclosed 3D anomaly detection techniques may utilize unsupervised training based on normal scans (e.g., images that do not show any abnormalities) to train the model(s) used to detect anomalies in the input 3D images. As disclosed in further detail below, at least some of the example 3D anomaly detection techniques are based on a pseudo-3D approach that divides an input 3D image data into multiple (e.g., three) different axes. For a given axis, at least some of the disclosed example 3D anomaly detection techniques then segment (e.g., slice) the input 3D image data into 2D image slices along the given axis, and group the 2D image slices into image blocks containing a number of 2D image slices (e.g. 64 or some other number of 2D image slices in each block). For each block, at least some of the disclosed example 3D anomaly detection techniques process the individual 2D image slices of the block with a 2D anomaly detection model to generate respective 2D anomaly maps (e.g., heat maps) corresponding respectively to the individual 2D image slices of the block. As disclosed in further detail below, a 2D anomaly map for a 2D image slice includes values that indicate (e.g., by representing respective likelihoods) whether corresponding pixels of the 2D image slice are or may be abnormal (e.g., correspond to an anomaly). As disclosed in further detail below, the same or different 2D anomaly detection models may be used to process different blocks of 2D image slices and/or blocks associated with different axes of the input 3D image.

Next, at least some of the disclosed example 3D anomaly detection techniques concatenate the 2D anomaly maps generated for the individual 2D image slices in the individual blocks for a given axis to generate respective 3D anomaly volumes for each of those blocks along the given axis (also referred to herein as 3D block-level anomaly volumes or 3D block-level anomaly sub-volumes). Additionally or alternatively, at least some of the disclosed example 3D anomaly detection techniques concatenate the 2D anomaly maps generated for the individual 2D image slices over all the blocks for a given axis to generate a 3D anomaly volume for that given axis (also referred to herein as a 3D axial anomaly volume for that given axis). Next, at least some of the disclosed example 3D anomaly detection techniques combine the respective 3D axial anomaly volumes generated for the different axes of the input 3D image data to generate and output a 3D anomaly volume (e.g., 3D heat volume) corresponding to the input 3D image. As disclosed in further detail below, a 3D anomaly volume (e.g., a 3D block-level anomaly volume, a 3D axial anomaly volume, a final output 3D anomaly volume, etc.) includes values that indicate (e.g., by representing respective likelihoods) whether corresponding voxels of the input 3D image are or may be abnormal (e.g., whether a given voxel corresponds to an anomaly).

In some disclosed examples, the values of the 3D anomaly volume are combined (e.g., accumulated, averaged, etc.) to determine an anomaly detection score that indicates whether the input 3D image as a whole exhibits at least one anomaly (e.g., based on comparison to a threshold). Additionally or alternatively, in some disclosed examples, the values of the 3D anomaly volume are compared to one or more thresholds to identify location(s) of the input 3D image that correspond to a particular anomaly.

Example 3D anomaly detection techniques disclosed herein utilize 2D anomaly detection models to build a 3D anomaly volume for an input 3D image based on 2D image slices of the input image, thereby avoiding the complexity of prior 3D anomaly detection techniques that process the input 3D image as a whole. As a result, example 3D anomaly detection techniques disclosed herein may consume fewer computational resources than prior approaches. For example, at least some disclosed 3D anomaly detection techniques may be trained and executed on central processing units (CPUs) without the need for more expensive graphics processing units (GPUs). As a result, at least some disclosed 3D anomaly detection techniques may be deployed on lower cost processing platforms, such as personal computers (PCs), workstations, efficient edge platforms including artificial intelligence (AI) enabled PCs, etc.

In the healthcare context, example 3D anomaly detection techniques disclosed herein can be used as an effective assistant tool to help radiologists quickly discard normal scans and point to relevant regions of interest in scans that need focused attention and/or human review. Thus, example 3D anomaly detection techniques disclosed herein can reduce the workloads of radiologists and the costs associated with evaluating medical scans.

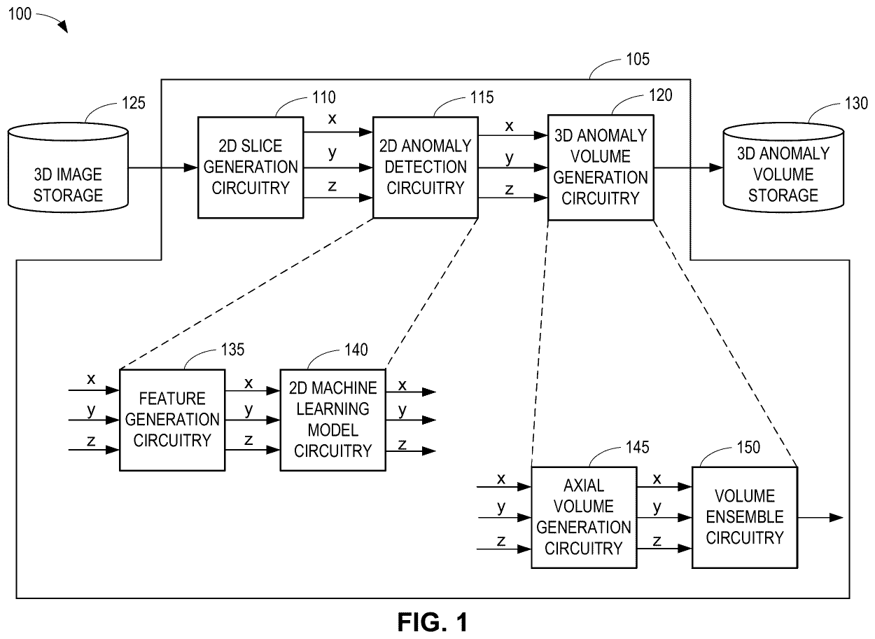

Turning to the figures, FIG. 1 is a block diagram of an example environment 100 in which an example 3D anomaly detector circuit 105 operates to detect anomalies in 3D images in accordance with teachings of this disclosure. The 3D anomaly detector circuit 105 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the 3D anomaly detector circuit 105 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example 3D anomaly detector circuit 105 of FIG. 1 includes example 2D slice generation circuitry 110, example 2D anomaly detection circuitry 115 and example 3D anomaly volume generation circuitry 120. The 3D anomaly detector circuit 105 of the illustrated example operates on input 3D images to generate respective 3D anomaly volumes corresponding to the input 3D images. As described above, a 3D anomaly volume generated for a given input 3D image includes values that indicate whether corresponding voxels of the input 3D image are or may be abnormal (e.g., whether a given voxel of the input 3D image corresponds to an anomaly). As such, in some examples, the 3D anomaly volume generated by the 3D anomaly detector circuit 105 for a given 3D input image may have the same size as the input image. For example, if the input 3D image has a size of N×N×N pixels (e.g., such as 256×256×256 pixels), the corresponding 3D anomaly volume may have the same size of N×N×N pixels (e.g., such as 256×256×256 pixels). In such an example, each value at a particular 1×1×1 location of the 3D anomaly volume corresponds to a particular 1×1×1 voxel of the input 3D image at that same location, with the value of the 3D anomaly volume indicating whether the corresponding voxel of the input 3D image corresponds to an anomaly depicted in the input 3D image (or, in other words, whether the corresponding voxel of the input 3D image is abnormal). In some examples, the values of the 3D anomaly volume may represent respective likelihoods that corresponding voxels of the input 3D image are associated with an anomaly or anomalies depicted in the input 3D image (or, in other words, whether the corresponding voxels of the input 3D image are abnormal). For example, larger values of the 3D anomaly volume may indicate locations of the 3D input image that are more likely to be associated with one or more anomalies. As such, a 3D anomaly volume is also referred to herein as a 3D heat volume as its larger (e.g., hotter) values indicate potential anomalies.

In the example environment of FIG. 1, the 3D anomaly detector circuit 105 obtains input 3D images from an example 3D image storage 125. The 3D image storage 125 can be implemented by any number(s) and/or type(s) of memories, storage devices, etc.

In the example environment of FIG. 1, the 3D anomaly detector circuit 105 outputs a generated 3D anomaly map for an input 3D image to an example 3D anomaly volume storage 130. The 3D anomaly volume storage 130 can be implemented by any number(s) and/or type(s) of memories, storage devices, etc. However, in some examples, the 3D anomaly detector circuit 105 additionally or alternatively causes a generated 3D anomaly map for a given input 3D image to be presented (e.g., displayed) on a local compute device including, implementing or otherwise associated with the 3D anomaly detector circuit 105. In some examples, the 3D anomaly detector circuit 105 additionally or alternatively causes a generated 3D anomaly map for a given input 3D image to be transmitted to a remote compute device for further processing.

The 3D anomaly detector circuit 105 of the illustrated example includes the 2D slice generation circuitry 110, the 2D anomaly detection circuitry 115 and the 3D anomaly volume generation circuitry 120 to generate a 3D anomaly map corresponding to an input 3D image. In the illustrated example, the 2D slice generation circuitry 110 segments (e.g., slices, divides, etc.) the input 3D image into 2D image slices along one or more axes of the input 3D image. For example, an input 3D image has three (3) axes, commonly referred to as the x-axis, the y-axis and the z-axis, or the x-direction, the y-direction and the z-direction. In some examples, the 2D slice generation circuitry 110 segments the input 3D image into a first collection of 2D image slices taken along the x-axis, a second collection of 2D image slices taken along the y-axis and a third collection of 2D image slices taken along the z-axis. For example, if the input 3D image has a size of N×N×N pixels (e.g., such as 256×256×256 pixels), the 2D slice generation circuitry 110 may segment the input 3D image into a first collection of N (e.g., 256) 2D image slices along the x-axis, with each 2D image slice having N×N pixels (e.g., 256×256 pixels). Likewise, the 2D slice generation circuitry 110 may segment the input 3D image into a second collection of N (e.g., 256) 2D image slices along the y-axis and a third collection of N (e.g., 256) 2D image slices along the z-axis, which each 2D image slice having N×N pixels (e.g., 256×256 pixels). However, in some examples, the 2D slice generation circuitry 110 may segment the input 3D image into 2D image slices along fewer than the total number of axes of the input 3D image.

In some examples, the 2D slice generation circuitry 110 also arranges consecutive 2D image slices taken along a given axis into multiple blocks of 2D image slices associated with that axis. The blocks of 2D image slices may also be referred to as image blocks, slice blocks, image groups, slice groups, etc. For example, if the input 3D image has a size of N×N×N pixels (e.g., such as 256×256×256 pixels) such that the 2D slice generation circuitry 110 generates a collection of N (e.g., 256) 2D image slices along a given axis, the 2D slice generation circuitry 110 may arrange the 2D image slices into N/M (e.g., 256/64=4) blocks of 2D image slices, with each block having M (e.g., 64) consecutive 2D image slices along that axis. Thus, a given block of 2D image slices along a given axis represents a 3D sub-volume corresponding to N×N×M pixels. In the illustrated example of FIG. 1, the 2D image slices (or slice blocks) generated by the 2D slice generation circuitry 110 for the x-axis, y-axis and z-axis of the input 3D image correspond respectively to the x, y and z labeled outputs of the 2D slice generation circuitry 110.

The 2D anomaly detection circuitry 115 of the illustrated example processes the 2D image slices generated by the 2D slice generation circuitry 110 for one or more of the axes of the input 3D image with one or more 2D anomaly detection models to generate respective 2D anomaly maps corresponding respectively to the individual 2D image slices. As described above, a 2D anomaly map for a given 2D image slice includes values that indicate whether corresponding pixels of the 2D image slice are or may be abnormal (e.g., whether a given pixel of the 2D image slice corresponds to an anomaly). As such, in some examples, the 2D anomaly map generated by the 2D anomaly detection circuitry 115 for a given 2D image slice may have the same size as the 2D image slice. For example, if the 2D image slice has a size of N×N pixels (e.g., such as 256×256 pixels), the corresponding 2D anomaly map may have the same size of N×N pixels (e.g., such as 256×256 pixels). In such an example, each value at a particular 1×1 location of the 2D anomaly map corresponds to a particular pixel of the 2D image slice at that same location, with the value of the 2D anomaly map indicating whether the corresponding pixel of the input 2D image slice to an anomaly depicted in the 2D image slice (or, in other words, whether the corresponding pixel of the 2D image slice is abnormal). In some examples, the values of the 2D anomaly map may represent respective likelihoods that corresponding pixels of the 2D image slice are associated with an anomaly or anomalies depicted in the 2D image slice (or, in other words, whether the corresponding pixels of the 2D image slice are abnormal). For example, larger values of the 2D anomaly map may indicate locations of the 2D input slice that are more likely to be associated with one or more anomalies. As such, a 2D anomaly map is also referred to herein as a 2D heat map as its larger (e.g., hotter) values indicate potential anomalies.

In the illustrated example, the 2D anomaly detection circuitry 115 processes the first collection of 2D image slices for the x-axis of the 3D input image (corresponding to the x labeled input of the 2D anomaly detection circuitry 115) to generate respective 2D anomaly maps corresponding to the first collection of 2D image slices for the x-axis of the 3D input image (corresponding to the x labeled output of the 2D anomaly detection circuitry 115). Likewise, in the illustrated example, the 2D anomaly detection circuitry 115 processes the second collection of 2D image slices for the y-axis of the 3D input image (corresponding to the y labeled input of the 2D anomaly detection circuitry 115) to generate respective 2D anomaly maps corresponding to the second collection of 2D image slices for the y-axis of the 3D input image (corresponding to the y labeled output of the 2D anomaly detection circuitry 115). Likewise, in the illustrated example, the 2D anomaly detection circuitry 115 processes the third collection of 2D image slices for the z-axis of the 3D input image (corresponding to the z labeled input of the 2D anomaly detection circuitry 115) to generate respective 2D anomaly maps corresponding to the third collection of 2D image slices for the z-axis of the 3D input image (corresponding to the y labeled output of the 2D anomaly detection circuitry 115).

The 2D anomaly detection circuitry 115 of the illustrated example can implement any appropriate 2D anomaly detection model or collection of 2D anomaly detection models to process the input 2D image slices to generate corresponding output 2D anomaly maps for the respective 2D image slices. In some examples, the 2D anomaly detection circuitry 115 processes a block of 2D image slices for a given axis with a same 2D anomaly detection model. In some such examples, the 2D anomaly detection model is trained based on a collection of training 2D image slices (also referred to as training 2D image frames, training slices, training frames, etc.) to detect one or more anomalies in the input 2D image slices (also referred to as input 2D image frames, input slices, input frames, etc.) However, in some examples, the 2D anomaly detection circuitry 115 processes different blocks of 2D image slices for a given axis with different 2D anomaly detection models. For example, the 2D anomaly detection circuitry 115 may process a first block of 2D image slices for the given axis with a first 2D anomaly detection model trained based on a first collection of training images, and may process a second block of 2D image slices for the given axis with a different second 2D anomaly detection model trained based on a second collection of training images (which may be the same or different from the first collection of training images). In some examples, the 2D anomaly detection circuitry 115 processes the 2D image slices for different axes with the same 2D anomaly detection model or combination of 2D anomaly detection models. For example, the 2D anomaly detection circuitry 115 may process the blocks of 2D image slices for a first axis (e.g., the x-axis) with a first 2D anomaly detection model or a first combination of 2D anomaly detection models (e.g., with different models used for different slice blocks), and may process the blocks of 2D image slices for a second axis (e.g., the y-axis) with the same first 2D anomaly detection model or first combination of 2D anomaly detection models (e.g., with corresponding slice blocks of different axes being processed with the same 2D anomaly detection model). However, in some examples, the 2D anomaly detection circuitry 115 processes the 2D image slices for different axes with different 2D anomaly detection models or combinations of 2D anomaly detection models. For example, the 2D anomaly detection circuitry 115 may process the blocks of 2D image slices for a first axis (e.g., the x-axis) with a first 2D anomaly detection model or a first combination of 2D anomaly detection models (e.g., with different models used for different slice blocks), and may process the blocks of 2D image slices for a second axis (e.g., the y-axis) with a different second 2D anomaly detection model or a different second combination of 2D anomaly detection models (e.g., with corresponding slice blocks of different axes being processed with different 2D anomaly detection models). Thus, the 2D anomaly detection circuitry 115 can implement multiple, different 2D anomaly detection models tailored (e.g., trained) for the particular image content expected in different sub-volumes of the 3D volume corresponding to the input image.

As noted above, the example 2D anomaly detection circuitry 115 can implement any appropriate 2D anomaly detection model or collection of 2D anomaly detection models to process the input 2D image slices to generate corresponding output 2D anomaly maps for the respective 2D image slices. For example, the 2D anomaly detection circuitry 115 can implement any machine learning model, heuristic model, regression model, etc., that is tailored, trained, etc., to detect an anomaly or multiple anomalies in a 2D image/frame. In the illustrated example of FIG. 1, the 2D anomaly detection circuitry 115 includes example feature generation circuitry 135 and example 2D machine learning model circuitry 140 to implement one such example 2D anomaly detection model. However, the 2D anomaly detection circuitry 115 is not limited to such an implementation and can include additional or alternative circuitry to implement any appropriate 2D anomaly detection model.

In the illustrated example of FIG. 1, the 2D anomaly detection circuitry 115 includes the feature generation circuitry 135 to generate respective neural network features, such a deep learning features, for each input 2D image slice and for each axis. For example, the feature generation circuitry 135 generates respective neural network features (corresponding to the x labeled output of the feature generation circuitry 135) for each input 2D image slice for the x-axis (corresponding to the x labeled input of the feature generation circuitry 135), generates respective neural network features (corresponding to the y labeled output of the feature generation circuitry 135) for each input 2D image slice for the y-axis (corresponding to the y labeled input of the feature generation circuitry 135), and generates respective neural network features (corresponding to the z labeled output of the feature generation circuitry 135) for each input 2D image slice for the z-axis (corresponding to the z labeled input of the feature generation circuitry 135). In some examples, the feature generation circuitry 135 implements a neural network having neural network layers trained to generated features that can be used for anomaly detection. In some such examples, the feature generation circuitry 135 processes a given input 2D image slice with the neural network, and the outputs of a selected layer of the neural network form the neural network features (e.g., deep learning features) for that input 2D image slice.

In the illustrated example of FIG. 1, the 2D anomaly detection circuitry 115 includes the 2D machine learning model circuitry 140 to process the respective neural network features, such a deep learning features, for each input 2D image slice and for each axis to generate the respective 2D anomaly maps for the input 2D image slice. For example the 2D machine learning model circuitry 140 processes the respective neural network features for each input 2D image slice for the x-axis (corresponding to the x labeled input of the 2D machine learning model circuitry 140) to generate the respective 2D anomaly maps associated with the input 2D image slices for the x-axis (corresponding to the x labeled output of the 2D machine learning model circuitry 140), processes the respective neural network features for each input 2D image slice for the y-axis (corresponding to the y labeled input of the 2D machine learning model circuitry 140) to generate the respective 2D anomaly maps associated with the input 2D image slices for the y-axis (corresponding to the y labeled output of the 2D machine learning model circuitry 140), and processes the respective neural network features for each input 2D image slice for the z-axis (corresponding to the z labeled input of the 2D machine learning model circuitry 140) to generate the respective 2D anomaly maps associated with the input 2D image slices for the z-axis (corresponding to the z labeled output of the 2D machine learning model circuitry 140). The 2D machine learning model circuitry 140 implements any machine learning model capable of generating a 2D anomaly map for a 2D image slice/frame based on neural network features (e.g., deep learning features) obtained for that 2D image slice/frame.

For example, the 2D machine learning model circuitry 140 may implement a principal component analysis (PCA) machine learning model that is trained to generate a reduced dimension embedding from the neural network features (e.g., deep learning features) obtained for that 2D image slice/frame. In some examples, the PCA model implemented by the 2D machine learning model circuitry 140 is trained based on a collection of training images to generated a reduced dimension embedding for an input 2D image slice/frame that provides a compact representation of the input 2D image slice/frame based on the assumption that the input 2D image slice/frame does not contain anomalies. In some examples, different collections of training images are used to train different PCA models to be used to process different blocks of 2D image slices along the same or different axes of the input image. In some such examples, the 2D machine learning model circuitry 140 generates the 2D anomaly map for a given input 2D image slice/frame based on the difference between the original input 2D image slice/frame and a reconstructed 2D slice/frame determined based on the reduced dimension embedding determined by the PCA model for that input 2D image slice/frame. For example, the 2D machine learning model circuitry 140 sets the values (e.g., scores) of the 2D anomaly map based on (e.g., equal to, proportional to, etc.) the feature reconstruction error (FRE) between pixels of the input 2D image slice/frame and corresponding pixels of the reconstructed 2D slice/frame. If the input 2D image slice/frame does not contain anomalies, the reconstructed 2D slice/frame determined from the reduced dimension embedding should be similar to the original input 2D image slice/frame, resulting in 2D anomaly map having low values (e.g., scores). However, if the 2D image slice/frame does contain one or more anomalies, the reconstructed 2D slice/frame determined from the reduced dimension embedding should be similar to the original input 2D image slice/frame at locations/regions that do not contain anomalies, but should be dissimilar to the original input 2D image slice/frame at locations/regions that contain one or more anomalies. As such, the resulting 2D anomaly map should have low values (e.g., scores) at locations/regions that do not contain anomalies, but have higher scores at locations/regions that contain one or more anomalies.

The 3D anomaly volume generation circuitry 120 of the illustrated example processes the 2D anomaly maps generated by the 2D anomaly detection circuitry 115 for the 2D image slices associated with one or more of the axes of the input 3D image to generate the 3D anomaly volume for the input 3D image. For example, the 3D anomaly volume generation circuitry 120 accesses the 2D anomaly maps generated by the 2D anomaly detection circuitry 115 for the 2D image slices associated with the x-axis of the input 3D image (corresponding to the x labeled input of the 3D anomaly volume generation circuitry 120), accesses the 2D anomaly maps generated by the 2D anomaly detection circuitry 115 for the 2D image slices associated with the y-axis of the input 3D image (corresponding to the y labeled input of the 3D anomaly volume generation circuitry 120), and accesses the 2D anomaly maps generated by the 2D anomaly detection circuitry 115 for the 2D image slices associated with the z-axis of the input 3D image (corresponding to the z labeled input of the 3D anomaly volume generation circuitry 120). The 3D anomaly volume generation circuitry 120 then combines, as described below, the accessed 2D anomaly maps to generate the 3D anomaly volume for the input 3D image.

In the illustrated example, the 3D anomaly volume generation circuitry 120 includes example axial volume generation circuitry 145 to concatenate the 2D anomaly maps corresponding to the individual 2D image slices for a given axis to generate a 3D axial anomaly volume for that given axis. A 3D axial anomaly volume is similar to the 3D anomaly volume but is based on the 2D anomaly maps corresponding to just one of the axis of the input 3D image. Thus, if the input 3D image has a size of N×N×N pixels (e.g., such as 256×256×256 pixels), the corresponding 3D axial anomaly volume for a given axis may have the same size of N×N×N pixels (e.g., such as 256×256×256 pixels), but is based on concatenating the N×N pixel (e.g., 256×256 pixel) 2D anomaly maps associated with just that given axis. For example, the axial volume generation circuitry 145 concatenates the 2D anomaly maps for the 2D image slices associated with the x-axis (corresponding to the x labeled input of the axial volume generation circuitry 145) to generate a 3D axial anomaly volume for the x-axis (corresponding to the x labeled output of the axial volume generation circuitry 145). Likewise, the axial volume generation circuitry 145 concatenates the 2D anomaly maps for the 2D image slices associated with the y-axis (corresponding to the y labeled input of the axial volume generation circuitry 145) to generate a 3D axial anomaly volume for the y-axis (corresponding to the y labeled output of the axial volume generation circuitry 145), and concatenates the 2D anomaly maps for the 2D image slices associated with the z-axis (corresponding to the z labeled input of the axial volume generation circuitry 145) to generate a 3D axial anomaly volume for the z-axis (corresponding to the z labeled output of the axial volume generation circuitry 145).

In some examples, the axial volume generation circuitry 145 concatenates the 2D anomaly maps corresponding to the 2D image slices in respective slice blocks along a given axis to generate respective 3D block-level anomaly volumes for that given axis. For example, if the input 3D image has a size of N×N×N pixels (e.g., such as 256×256×256 pixels), and a slice block along a given axis includes M slices (e.g., such as 64 slices), then the 3D block-level anomaly volumes for that given axis will each have a size of N×N×M pixels (e.g., such as 256×256×64 pixels). As such, each 3D block-level anomaly volume along a given axis represents a 3D sub-volume of N×N×M pixels (e.g., such as 256×256×64 pixels) along that axis. Thus, in some examples, the axial volume generation circuitry 145 concatenates the 2D anomaly maps for the 2D image slices in different slice blocks along the x-axis (corresponding to the x labeled input of the axial volume generation circuitry 145) to generate respective 3D block-level anomaly volumes for the x-axis (corresponding to the x labeled output of the axial volume generation circuitry 145). In some such examples, the axial volume generation circuitry 145 then concatenates the respective 3D block-level anomaly volumes for the x-axis to generate the 3D axial anomaly volume for the x-axis. Likewise, the axial volume generation circuitry 145 concatenates the 2D anomaly maps for the 2D image slices in different slice blocks along the y-axis (corresponding to the y labeled input of the axial volume generation circuitry 145) to generate respective 3D block-level anomaly volumes for the y-axis (corresponding to the y labeled output of the axial volume generation circuitry 145), and concatenates the 2D anomaly maps for the 2D image slices in different slice blocks along the z-axis (corresponding to the z labeled input of the axial volume generation circuitry 145) to generate respective 3D block-level anomaly volumes for the z-axis (corresponding to the z labeled output of the axial volume generation circuitry 145). In some such examples, the axial volume generation circuitry 145 then concatenates the respective 3D block-level anomaly volumes for the y-axis to generate the 3D axial anomaly volume for the y-axis, and concatenates the respective 3D block-level anomaly volumes for the z-axis to generate the 3D axial anomaly volume for the z-axis.

In the illustrated example, the 3D anomaly volume generation circuitry 120 includes example volume ensemble circuitry 150 to combine the 3D axial anomaly volumes from the axial volume generation circuitry 145 to generate the 3D anomaly volume corresponding to the input 3D image. For example, the volume ensemble circuitry 150 accesses the 3D axial anomaly volume generated by the axial volume generation circuitry 145 for the x-axis of the input 3D image (corresponding to the x labeled input of the axial volume generation circuitry 145), accesses the 3D axial anomaly volume generated by the axial volume generation circuitry 145 for the y-axis of the input 3D image (corresponding to the y labeled input of the axial volume generation circuitry 145), and accesses the 3D axial anomaly volume generated by the axial volume generation circuitry 145 for the z-axis of the input 3D image (corresponding to the z labeled input of the axial volume generation circuitry 145). Next, using one axis (e.g., such as the x-axis) of the input 3D image as reference, the volume ensemble circuitry 150 rotates the 3D axial anomaly volumes for the other axes (e.g., such as the y-axis and the z-axis) based on their relationships of their axes to the reference axis (e.g., the x-axis) to determine rotated 3D axial anomaly volumes for those respective axes. Such rotation causes the rotated 3D axial anomaly volumes to align with the 3D axial anomaly volume for the reference axis in 3D space. The volume ensemble circuitry 150 then combines the 3D axial anomaly volume for the reference axis (e.g., referred to herein as the reference 3D axial anomaly volume) with the rotated 3D axial anomaly volumes for the other axes. For example, for each pixel location in the 3D anomaly volume corresponding to the input 3D image, the volume ensemble circuitry 150 may average, sum, etc., the value of the reference 3D axial anomaly volume at that pixel location and the respective values of the rotated 3D axial anomaly volumes at that location to determine the value of the 3D anomaly volume at that location.

In some examples, the volume ensemble circuitry 150 combines the 3D block-level anomaly volumes from different axes that correspond to the same sub-volume of the input 3D image to generate respective 3D anomaly sub-volumes corresponding to different locations of the input 3D image. For example, the volume ensemble circuitry 150 may access the 3D block-level anomaly volume generated by the axial volume generation circuitry 145 for a given slice block along the x-axis of the input 3D image (e.g., corresponding to a given sub-volume of the input 3D image), may access the 3D block-level anomaly volume generated by the axial volume generation circuitry 145 for a corresponding slice block along y-axis of the input 3D image (e.g., corresponding to the same sub-volume of the input 3D image), and may access the 3D block-level anomaly volume generated by the axial volume generation circuitry 145 for the corresponding slice block along the z-axis of the input 3D image (e.g., corresponding to the same sub-volume of the input 3D image). Next, using one axis (e.g., such as the x-axis) of the input 3D image as reference, the volume ensemble circuitry 150 rotates the 3D block-level anomaly volumes for the other axes (e.g., such as the y-axis and the z-axis) based on their relationships of their axes to the reference axis (e.g., the x-axis) to determine rotated 3D block-level anomaly volumes for those respective axes. Such rotation causes the rotated 3D block-level anomaly volumes to align with the 3D block-level anomaly volume for the reference axis in 3D space. The volume ensemble circuitry 150 then combines the 3D block-level anomaly volume for the reference axis (e.g., referred to herein as the reference 3D block-level anomaly volume) with the rotated 3D block-level anomaly volumes for the other axes. For example, for each pixel location in the 3D block-level anomaly volume corresponding to the particular sub-volume of the input 3D image, the volume ensemble circuitry 150 may average, sum, etc., the values of the reference 3D block-level anomaly volume at that pixel location and the respective values of the rotated 3D block-level anomaly volumes at that location to determine the value of the 3D anomaly sub-volume at that location.

In the illustrated example, the 3D anomaly volume generation circuitry 120 outputs the generated 3D anomaly map for the input 3D image to the 3D anomaly volume storage 130. However, in some examples, the 3D anomaly volume generation circuitry 120 additionally or alternatively causes the generated 3D anomaly map for the given input 3D image to be presented (e.g., displayed) on a local compute device including, implementing or otherwise associated with the 3D anomaly detector circuit 105. In some examples, the 3D anomaly volume generation circuitry 120 additionally or alternatively causes the generated 3D anomaly map for the given input 3D image to be transmitted to a remote compute device for further processing.

In some examples, the 3D anomaly volume generation circuitry 120 (e.g., the volume ensemble circuitry 150) accumulates, averages, etc., or otherwise combines the values of the output 3D anomaly volume are combined to determine an overall anomaly detection score that indicates whether the input 3D image as a whole exhibits at least one anomaly. For example, the 3D anomaly volume generation circuitry 120 (e.g., the volume ensemble circuitry 150) may compare the overall anomaly detection score to a threshold and indicate the input 3D image as a whole exhibits at least one anomaly if the overall anomaly detection score satisfies (e.g., meets or exceeds) the threshold. Additionally or alternatively, in some disclosed examples, the 3D anomaly volume generation circuitry 120 (e.g., the volume ensemble circuitry 150) compares the individual values of the 3D anomaly volume to one or more thresholds to identify location(s) of the input 3D image that correspond to a particular anomaly.

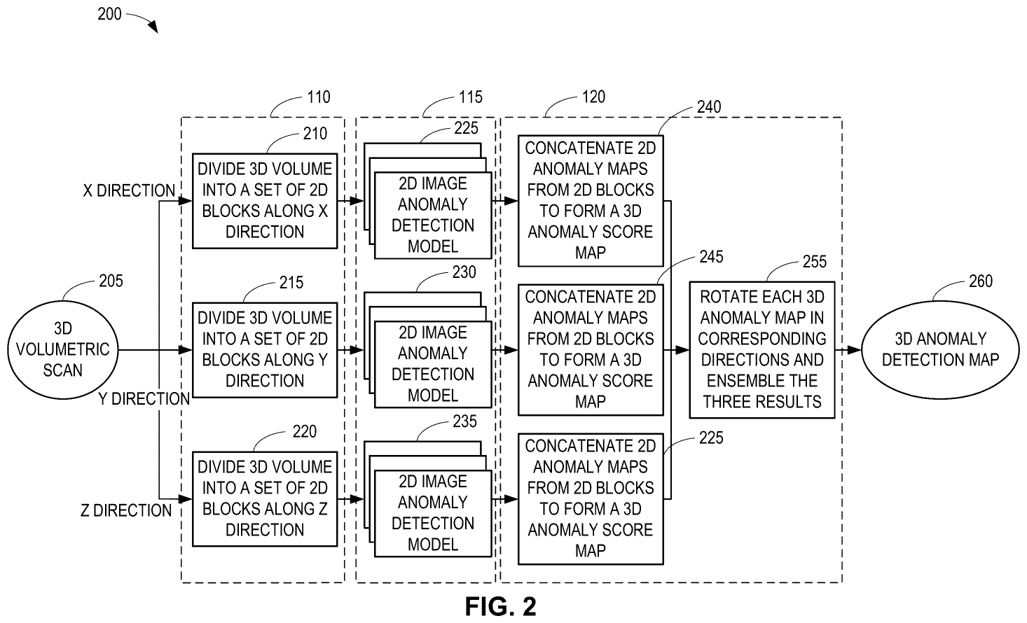

FIG. 2 illustrates example operations 200 performed by the 3D anomaly detector circuit 105 of FIG. 1 to detect an anomaly in an input 3D image. In the illustrated example of FIG. 2, the 2D slice generation circuitry 110 obtains an example 3D input image 205 (e.g., from the 3D image storage 125). In the illustrated example, the 3D input image 205 is a 3D volumetric medical scan. As described above, the 2D slice generation circuitry 110 divides (e.g., slices) the 3D input image 205 into a first set 2D images slices along the x-axis (or x-direction) of the 3D input image 205 and groups the first set 2D images slices into a first set of blocks of consecutive 2D images slices (corresponding to operation 210 of FIG. 2). Likewise, the 2D slice generation circuitry 110 divides (e.g., slices) the 3D input image 205 into a second set 2D images slices along the y-axis (or y-direction) of the 3D input image 205 and groups the second set 2D images slices into a second set of blocks of consecutive 2D images slices (corresponding to operation 215 of FIG. 2). Likewise, the 2D slice generation circuitry 110 divides (e.g., slices) the 3D input image 205 into a third set 2D images slices along the z-axis (or z-direction) of the 3D input image 205 and groups the third set 2D images slices into a third set of slice blocks of consecutive 2D images slices (corresponding to operation 220 of FIG. 2). For example, if the input 3D image has a size of 256×256×256 pixels, then each block may contain, for example, 64 image slices of 256×256 pixels such that there are 4 slice blocks for each axis.

Next, the 2D anomaly detection circuitry 115 processes, as described above, each block of consecutive 2D images slices along the x-axis (or x-direction) with a 2D anomaly detection model to generate respective 2D anomaly maps corresponding to the 2D images slices for the x-axis (corresponding to operation 225 of FIG. 2). Likewise, the 2D anomaly detection circuitry 115 processes each block of consecutive 2D images slices along the y-axis (or y-direction) with a 2D anomaly detection model to generate respective 2D anomaly maps corresponding to the 2D images slices for the y-axis (corresponding to operation 230 of FIG. 2). Likewise, the 2D anomaly detection circuitry 115 processes each block of consecutive 2D images slices along the z-axis (or z-direction) with a 2D anomaly detection model to generate respective 2D anomaly maps corresponding to the 2D images slices for the z-axis (corresponding to operation 235 of FIG. 2).

In the illustrated example, the 2D anomaly detection circuitry 115 implements different 2D anomaly detection models to process the different slice blocks along the x-axis, y-axis and z-axis. For example, the 2D anomaly detection circuitry 115 may implement a common model structure for the different 2D anomaly detection models (e.g., such as the PCA-based model structure described above in connection with FIG. 1), but train the different 2D anomaly detection models with different sets of training images. Such an implementation is based on findings that different parts of an imaging target (such as the brain, the abdominal cavity, etc.) can have substantially different image voxel distribution.

Next, the 3D anomaly volume generation circuitry 120 concatenates, as described above, the respective 2D anomaly maps determined for the 2D image slices along the x-axis (or x-direction) to form a 3D axial anomaly volume associated with the x-axis (corresponding to operation 240 of FIG. 2). In some examples, at operation 240, the 3D anomaly volume generation circuitry 120 also concatenates, as described above, the respective blocks of 2D anomaly maps determined for respective slice blocks along the x-axis (or x-direction) to form the respective 3D block-level anomaly volumes associated with corresponding sub-volumes along the x-axis (or x-direction). Likewise, the 3D anomaly volume generation circuitry 120 concatenates the respective 2D anomaly maps determined for the 2D image slices along the y-axis (or y-direction) to form a 3D axial anomaly volume associated with the y-axis (corresponding to operation 245 of FIG. 2). In some examples, at operation 245, the 3D anomaly volume generation circuitry 120 also concatenates, as described above, the respective blocks of 2D anomaly maps determined for respective slice blocks along the y-axis (or y-direction) to form the respective 3D block-level anomaly volumes associated with corresponding sub-volumes along the y-axis (or y-direction). Likewise, the 3D anomaly volume generation circuitry 120 concatenates the respective 2D anomaly maps determined for the 2D image slices along the z-axis (or z-direction) to form a 3D axial anomaly volume associated with the z-axis (corresponding to operation 250 of FIG. 2). In some examples, at operation 250, the 3D anomaly volume generation circuitry 120 also concatenates, as described above, the respective blocks of 2D anomaly maps determined for respective slice blocks along the z-axis (or z-direction) to form the respective 3D block-level anomaly volumes associated with corresponding sub-volumes along the z-axis (or z-direction).

Next, the 3D anomaly volume generation circuitry 120 combines the 3D axial anomaly volumes associated with the x-axis, the y-axis and the z-axis, as described above (corresponding to operation 255 of FIG. 2) to generate an example 3D anomaly volume 260 corresponding to the input 3D image 204. As described above, the 3D anomaly volume generation circuitry 120 may rotate one or more of the 3D axial anomaly volumes prior to combining (e.g., to cause the 3D axial anomaly volumes to align properly in 3D space) and then average, sum, etc., the corresponding values of the 3D axial anomaly volumes to generate the 3D anomaly volume 260.

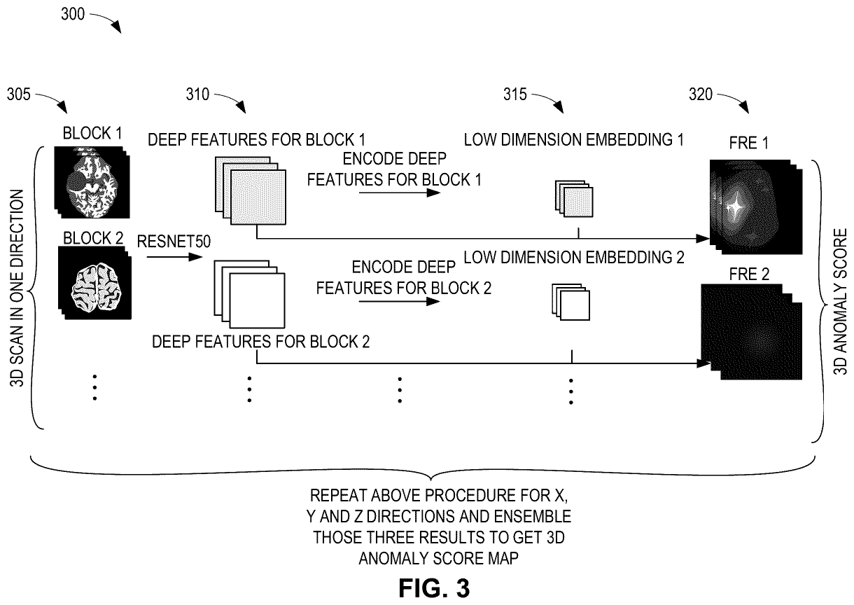

FIG. 3 illustrates an example 2D anomaly detection model 300 implemented by the 3D anomaly detector circuit 105 of FIG. 1. The 2D anomaly detection model 300 can be implemented by the feature generation circuitry 135 and the 2D machine learning model circuitry 140 of FIG. 1. In the illustrated example of FIG. 3, the feature generation circuitry 135 accesses an example block 305 of 2D image slices corresponding to a given axis of a 3D input image. Next, the feature generation circuitry 135 processes each 2D image slice of the block 305 with a neural network to obtain respective sets of example neural network features (e.g., deep learning features) 310 corresponding respectively to the 2D image slices of the block 305. Next, the 2D machine learning model circuitry 140 implements a PCA model to process the respective sets of neural network features 310 to determine respective example reduced dimensionality embeddings 315 corresponding respectively the 2D image slices of the block 305. Next, the 2D anomaly detection model 300 determines respective example 2D anomaly maps 320 corresponding respectively to the 2D image slices of the block 305. For example, the 2D anomaly detection model 300 determines the 2D anomaly map corresponding to a given 2D image slice of the block 305 based on (e.g., equal to, proportional to, etc.) the feature reconstruction error (FRE) between the 2D image slice and a reconstructed version of the 2D image slice determined using its respective reduced dimensionality embedding 315. The 3D anomaly detector circuit 105 then continues to perform the above operation for successive slice blocks associated with the given axis (or give direction) and then for the slice blocks associated with other axes (other directions) of the input 3D image.

With reference to FIGS. 1-3, in some examples, the functionality implemented by the 3D anomaly detector circuit 105 of FIG. 1 can be allocated to different compute devices at different locations to achieve a privacy-conscious solution. For example, consider a healthcare application in which the 3D anomaly detector circuit 105 is to detect anomalies in 3D medical scans. In such an example, the 3D image storage 125 storing the 3D medical scans can be located at a secure facility (e.g., such as a healthcare facility, hospital, medical center, etc.). Furthermore, the image slicing functionality of the 2D slice generation circuitry 110 and the neural network feature generation functionality of the feature generation circuitry 135 can be implemented by one or more compute devices at the secure facility. The remaining functionality of the 3D anomaly detector circuit 105, such as the 2D machine learning model functionality of the 2D machine learning model circuitry 140, the 2D anomaly map to 3D anomaly volume generation functionality of the 3D anomaly volume generation circuitry 120 can be implemented by one or more other compute devices remote from the secure facility (e.g., such as by one or more edge servers, by a cloud computing facility, etc.).

In this manner, the privacy of the 3D medical scans is maintained as that do not need to be transmitted off premises for anomaly detection. Rather, just the neural network features (e.g., deep learning features) generated for the 3D medical scans are transmitted off premises for processing. As such, raw data is not transmitted externally and remains within the client's control. The 3D medical scans are converted to neural network features that obfuscate the details of the original scan, thereby enhancing data privacy. The neural network features are transmitted to a remote location (e.g., an edge server), where the remaining anomaly detection functions are deployed. The remote location (e.g., edge server) is equipped with the computational resources to remaining anomaly detection functions of the 3D anomaly detector circuit 105 to identify deviations from normal patterns within the features, which may indicate the presence of anomalies. Upon detecting anomalies, the remote location (e.g., edge server) generates an anomaly map that visually represents the locations and severities of the detected anomalies. In some examples, this map is then securely transmitted back to the client. The transmission ensures that the client receives actionable insights without compromising the privacy of the original 3D scan data.

Also, the 3D anomaly detector circuit 105 is versatile and not constrained by the type of 3D scan source. Rather, the 3D anomaly detector circuit 105 is compatible with a wide array of imaging technologies. This includes, but is not limited to, computed tomography (CT) scans, X-ray scans, ultrasound imaging, magnetic resonance imaging (MRI) scans, etc.

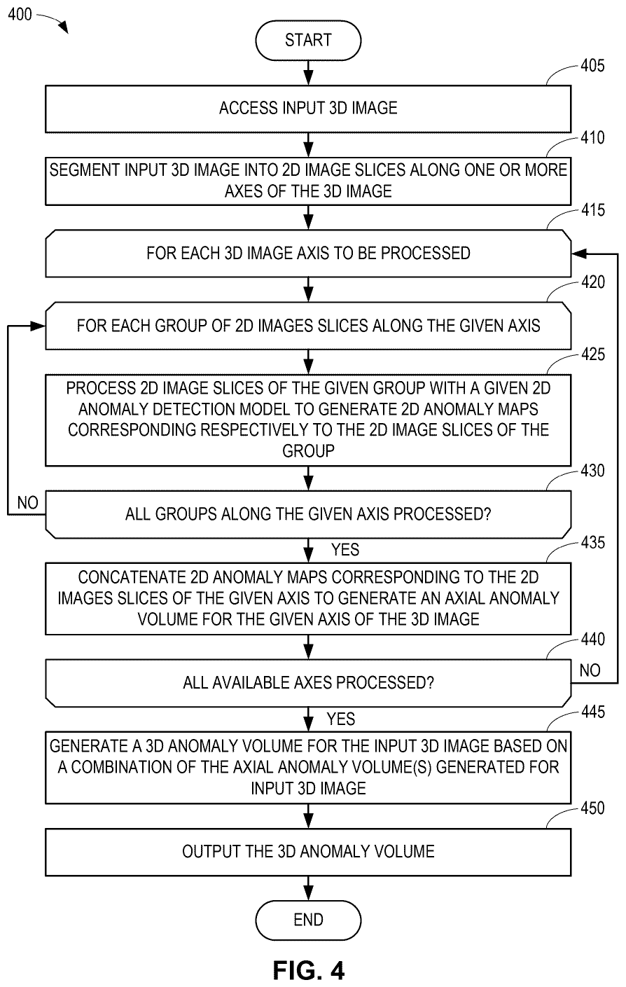

In some examples, the 2D slice generation circuitry 110 is instantiated by programmable circuitry executing 2D slice generation instructions and/or configured to perform operations such as those represented by the flowchart(s) of FIG. 4. In some examples, the 2D anomaly detection circuitry 115 is instantiated by programmable circuitry executing 2D anomaly detection instructions and/or configured to perform operations such as those represented by the flowchart(s) of FIGS. 4-6. In some examples, the 3D anomaly volume generation circuitry 120 is instantiated by programmable circuitry executing 3D anomaly volume generation instructions and/or configured to perform operations such as those represented by the flowchart(s) of FIG. 4.

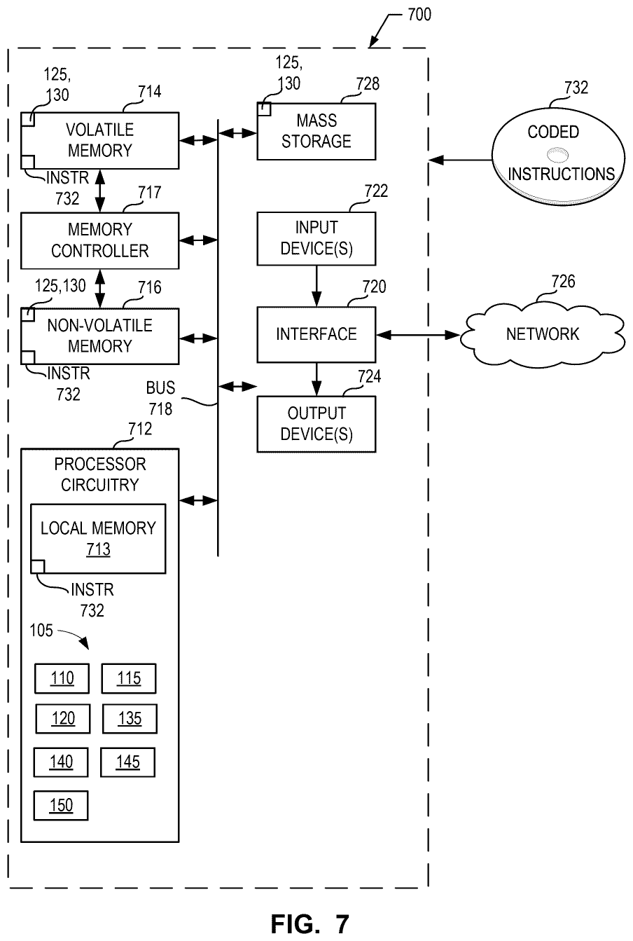

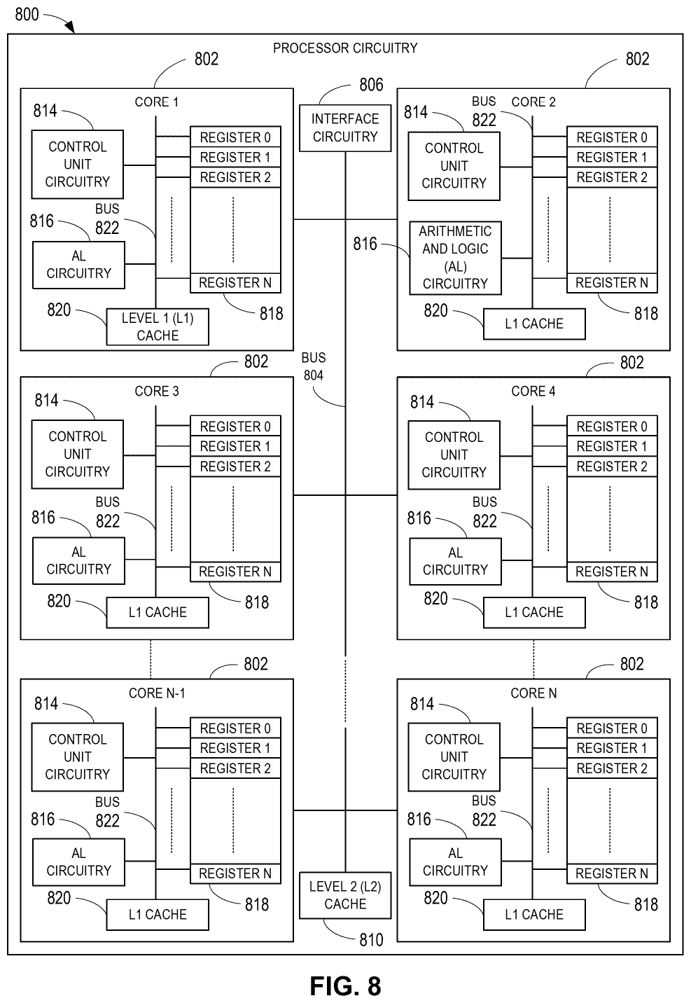

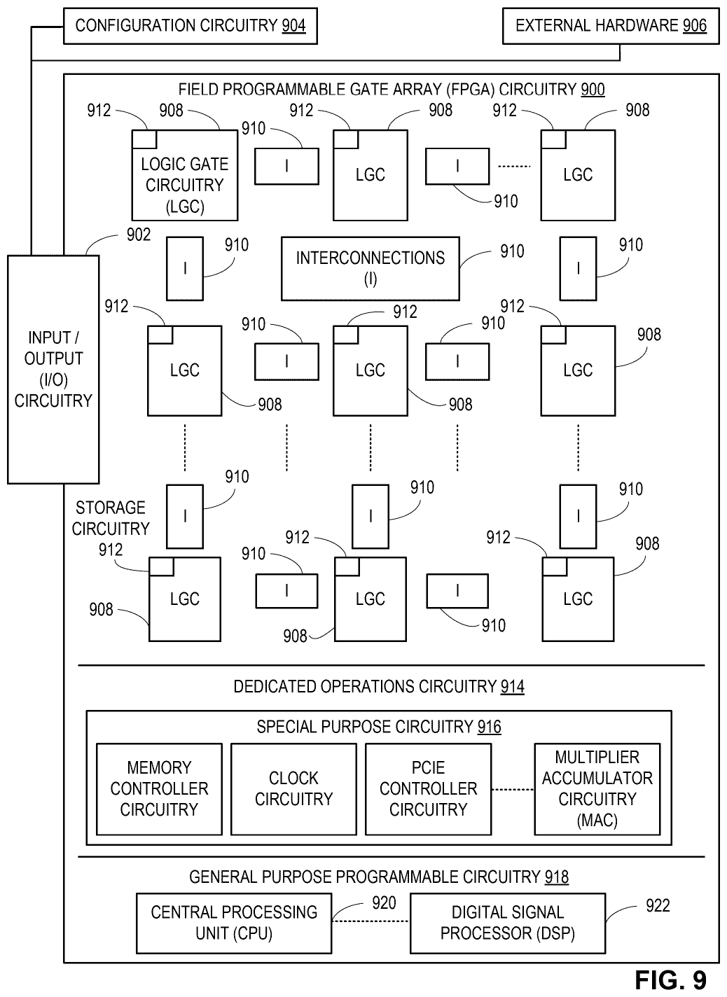

In some examples, the 3D anomaly detector circuit 105 includes means for generating 2D slices of a 3D image. For example, the means for generating 2D slices may be implemented by the 2D slice generation circuitry 110. In some examples, the 2D slice generation circuitry 110 may be instantiated by programmable circuitry such as the example programmable circuitry 712 of FIG. 7. For instance, the 2D slice generation circuitry 110 may be instantiated by the example microprocessor 800 of FIG. 8 executing machine executable instructions such as those implemented by at least blocks 405 and 410 of FIG. 4. In some examples, the 2D slice generation circuitry 110 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the 2D slice generation circuitry 110 may be instantiated by any other combination of hardware, software, and/or firmware. For example, the 2D slice generation circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

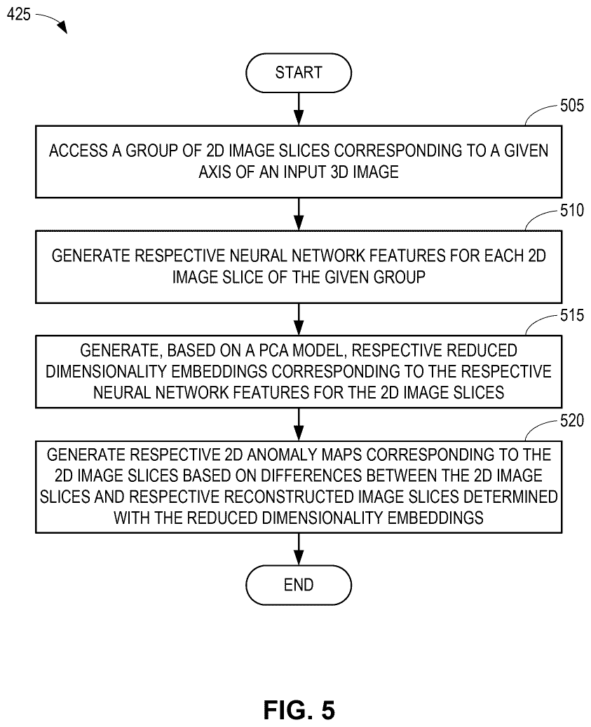

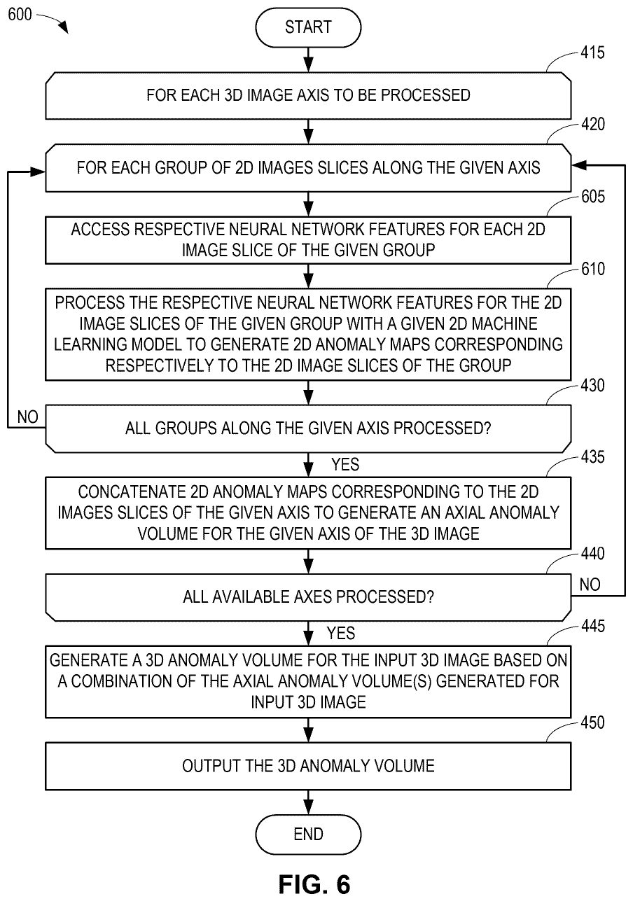

In some examples, the 3D anomaly detector circuit 105 includes means for performing 2D anomaly detection. For example, the means for performing 2D anomaly detection may be implemented by the 2D anomaly detection circuitry 115. In some examples, the 2D anomaly detection circuitry 115 may be instantiated by programmable circuitry such as the example programmable circuitry 712 of FIG. 7. For instance, the 2D anomaly detection circuitry 115 may be instantiated by the example microprocessor 800 of FIG. 8 executing machine executable instructions such as those implemented by at least blocks 420-430 of FIG. 4, blocks 505-520 of FIG. 5, and/or blocks 420, 605, 610 and 430 of FIG. 6. In some examples, the 2D anomaly detection circuitry 115 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the 2D anomaly detection circuitry 115 may be instantiated by any other combination of hardware, software, and/or firmware. For example, the 2D anomaly detection circuitry 115 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the 3D anomaly detector circuit 105 includes means for generating 3D anomaly volumes from 2D anomaly maps. For example, the means for generating 3D anomaly volumes may be implemented by the 3D anomaly volume generation circuitry 120. In some examples, the 3D anomaly volume generation circuitry 120 may be instantiated by programmable circuitry such as the example programmable circuitry 712 of FIG. 7. For instance, the 3D anomaly volume generation circuitry 120 may be instantiated by the example microprocessor 800 of FIG. 8 executing machine executable instructions such as those implemented by at least blocks 435-450 of FIG. 4. In some examples, the 3D anomaly volume generation circuitry 120 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the 3D anomaly volume generation circuitry 120 may be instantiated by any other combination of hardware, software, and/or firmware. For example, the 3D anomaly volume generation circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the 3D anomaly detector circuit 105 is illustrated in FIG. 1, one or more of the elements, processes, and/or devices illustrated in FIG. 1 may be combined, divided, re-arranged, omitted, eliminated, and/or implemented in any other way. Further, the example 2D slice generation circuitry 110, the example 2D anomaly detection circuitry 115, the example 3D anomaly volume generation circuitry 120, the example 3D image storage 125, the example 3D anomaly volume storage 130, the example feature generation circuitry 135, the example 2D machine learning model circuitry 140, the example axial volume generation circuitry 145, the example volume ensemble circuitry 150 and/or, more generally, the example 3D anomaly detector circuit 105 of FIG. 1, may be implemented by hardware alone or by hardware in combination with software and/or firmware. Thus, for example, any of the example 2D slice generation circuitry 110, the example 2D anomaly detection circuitry 115, the example 3D anomaly volume generation circuitry 120, the example 3D image storage 125, the example 3D anomaly volume storage 130, the example feature generation circuitry 135, the example 2D machine learning model circuitry 140, the example axial volume generation circuitry 145, the example volume ensemble circuitry 150, and/or, more generally, the example 3D anomaly detector circuit 105, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example 3D anomaly detector circuit 105 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the 3D anomaly detector circuit 105 of FIG. 1 and/or representative of example operations which may be performed by programmable circuitry to implement and/or instantiate the 3D anomaly detector circuit 105 of FIG. 1, are shown in FIGS. 4-6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-6, many other methods of implementing the example 3D anomaly detector circuit 105 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to implement the 3D anomaly detector circuit 105 of FIG. 1. The example machine-readable instructions and/or the example operations 400 of FIG. 4 begin at block 405, at which the 2D slice generation circuitry 110 of the 3D anomaly detector circuit 105 accesses an input 3D image from the 3D image storage 125. At block 410, the 2D slice generation circuitry 110 segments the input 3D image into 2D image slices along one or more axes of the input 3D image, as described above.

At block 415, the 3D anomaly detector circuit 105 begins iterating over the axes of the input 3D image to be used to generate a 3D anomaly volume corresponding to the input 3D image. At block 420, the 3D anomaly detector circuit 105 begins iterating over each group of 3D image slices determined by the 2D slice generation circuitry 110 for the current axis of the input 3D image being processed. At block 425, the 2D anomaly detection circuitry 115 of the 3D anomaly detector circuit 105 processes the 2D image slices of the current slice group with a given 2D anomaly detection model, as described above, to generate respective 3D anomaly maps corresponding respectively to the 2D image slices of the current slice group. At block 430, the 3D anomaly detector circuit 105 continues iterating over each group of 3D image slices determined for the current axis being processed.

After all slice groups for the current axis have been processed, at block 435 the 3D anomaly volume generation circuitry 120 of the 3D anomaly detector circuit 105 concatenates the 2D anomaly maps corresponding to the 2D image slices of the current axis being processed to generate an axial 3D anomaly volume for the current axis, as described above. In some examples, at block 435, the 3D anomaly volume generation circuitry 120 also concatenates the 2D anomaly maps associated with the respective slice groups along the current axis to generate respective 3D block-level anomaly volumes corresponding to the respective sub-volumes along the current axis, as described above. At block 440, the 3D anomaly detector circuit 105 continues iterating of the axes of the input 3D image.

After iteration over the axes of the input 3D image has completed, at block 445, the 3D anomaly volume generation circuitry 120 generates, as described above, a 3D anomaly volume for the input 3D image based on a combination of the axial 3D anomaly volumes generated for the respective axes of the input 3D image. At block 450, the 3D anomaly volume generation circuitry 120 outputs the 3D anomaly volume generated for the input 3D image. Execution of the example machine-readable instructions and/or the example operations 400 then ends.

FIG. 5 is a flowchart representative of example machine readable instructions and/or example operations 425 that may be executed, instantiated, and/or performed by programmable circuitry to implement the processing at block 425 of FIG. 4. The example machine-readable instructions and/or the example operations 400 of FIG. 4 begin at block 505, at which the feature generation circuitry 135 of the 2D anomaly detection circuitry 115 accesses a group of the 2D image slices corresponding to a given axis of the input 3D image. At block 510, the feature generation circuitry 135 generates respective neural network features for each 2D image slice of the given group, as described above. At block 515, the 2D machine learning model circuitry 140 of the 2D anomaly detection circuitry 115 generates, based on a PCA model, respective reduced dimensionality embeddings corresponding to the respective neural network features for the respective 2D image slices, as described above. At block 520, the 2D machine learning model circuitry 140 generates, as described above, respective 2D anomaly maps corresponding respectively to the 2D image slices based on differences between the original 2D image slices and respective reconstructed 2D image slices determined with the reduced dimensionality embeddings. Execution of the example machine-readable instructions and/or the example operations 425 then ends.

FIG. 6 is a flowchart representative of second example machine readable instructions and/or example operations 600 that may be executed, instantiated, and/or performed by programmable circuitry to implement the 3D anomaly detector circuit 105 of FIG. 1. The example machine-readable instructions and/or the example operations 600 of FIG. 6 correspond to a privacy-conscious implementation in which the 3D anomaly detector circuit 105 receives, from a remote compute device, neural network features (e.g., deep learning features) corresponding to 2D image slices of a 3D image that is to undergo anomaly detection. The example machine-readable instructions and/or the example operations 600 of FIG. 6 include blocks with similar functionality as blocks included in the example machine-readable instructions and/or the example operations 400 of FIG. 4. As such, those blocks are labeled with the same reference numerals, and the descriptions of those blocks are provided above in the description of FIG. 4.

With that in mind, the example machine-readable instructions and/or the example operations 600 of FIG. 4 begin at block 415, which is described above in the description of FIG. 4. Processing proceeds to block 420, which is also described above in the description of FIG. 4. Next, at block 605, the feature generation circuitry 135 of the 2D anomaly detection circuitry 115 accesses respective neural network features (e.g., deep learning features) for each 2D image slice in a current slice group being processed. At block 610, the 2D machine learning model circuitry 140 of the 2D anomaly detection circuitry 115 processes the respective neural network features for the 2D image slices of the current slice group with a given 2D machine learning model to generate 2D anomaly maps corresponding respectively to the 2D images slices of the group, as described above. The remaining processing at blocks 430-450 of FIG. 6 proceeds as described above in the description of FIG. 4. Execution of the example machine-readable instructions and/or the example operations 600 then ends.

FIG. 7 is a block diagram of an example programmable circuitry platform 700 structured to execute and/or instantiate the example machine-readable instructions and/or the example operations of FIGS. 4-6 to implement the 3D anomaly detector circuit 105 of FIG. 1. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements one or more of the example 2D slice generation circuitry 110, the example 2D anomaly detection circuitry 115, the example 3D anomaly volume generation circuitry 120, the example feature generation circuitry 135, the example 2D machine learning model circuitry 140, the example axial volume generation circuitry 145, the example volume ensemble circuitry 150 and/or, more generally, the example 3D anomaly detector circuit 105 of FIG. 1.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716. In some examples, the main memory 714 and/or 716 implement the example 3D image storage 125 and/or the example 3D anomaly volume storage 130 of FIG. 1.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, one or more mass storage discs or devices 728 implement the example 3D image storage 125 and/or the example 3D anomaly volume storage 130 of FIG. 1.

The machine readable instructions 732, which may be implemented by the machine readable instructions of FIGS. 4-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 4-6 to effectively instantiate the circuitry of FIG. 1 as logic circuits to perform operations corresponding to those machine readable instructions. In some such examples, the circuitry of FIG. 1 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 4-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-6. As such, the FPGA circuitry 900 may be configured and/or structured to effectively instantiate some or all of the operations/functions corresponding to the machine readable instructions of the flowchart(s) of FIGS. 4-6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 4-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 4-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 4-6 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 4-6, and/or an ASIC may be configured and/or structured to perform third operation(s)/function(s) corresponding to a third portion of the machine readable instructions represented by the flowcharts of FIGS. 4-6.

It should be understood that some or all of the circuitry of FIG. 1 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 1 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

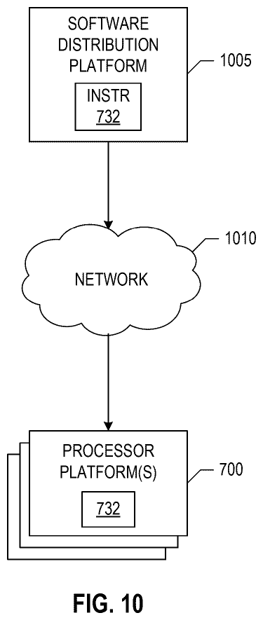

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 4-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 4-6, may be downloaded to the example programmable circuitry platform 700, which is to execute the machine readable instructions 732 to implement the 3D anomaly detector circuit 105. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that detect anomalies in 3D images. Disclosed systems, apparatus, articles of manufacture, and methods improve the efficiency of using a computing device by utilizing 2D anomaly detection models to build a 3D anomaly volume for an input 3D image based on 2D image slices of the input image, thereby avoiding the complexity of prior 3D anomaly detection techniques that process the input 3D image as a whole. As a result, example 3D anomaly detection techniques disclosed herein may consume fewer computational resources than prior approaches. For example, at least some disclosed 3D anomaly detection techniques may be trained and executed on CPUs without the need for more expensive GPUs. As a result, at least some disclosed 3D anomaly detection techniques may be deployed on lower cost processing platforms, such as PCs, workstations, efficient edge platforms including AI enabled PCs, etc. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus to detect an anomaly in a three-dimensional (3D) image, the apparatus comprising interface circuitry, computer readable instructions, and at least one processor circuit to be programmed by the computer readable instructions to generate a first two-dimensional (2D) anomaly map corresponding to a first 2D image slice of the 3D image, the first 2D image slice corresponding to a first axis of the 3D image, generate a second 2D anomaly map corresponding to a second 2D image slice of the 3D image, the second 2D image slice corresponding to a second axis of the 3D image, and generate a 3D anomaly volume based on the first 2D anomaly map and the second 2D anomaly map, the 3D anomaly volume corresponding to the 3D image.

Example 2 includes the apparatus of example 1, wherein the first 2D anomaly map includes first values corresponding respectively to pixels of the first 2D image slice, the first values to represent respective likelihoods that corresponding ones of the pixels of the first 2D image slice are abnormal, the second 2D anomaly map includes second values corresponding respectively to pixels of the second 2D image slice, the second values to represent respective likelihoods that corresponding ones of the pixels of the second 2D image slice are abnormal, and the 3D anomaly volume includes third values corresponding respectively to voxels of the 3D image, the third values to represent respective likelihoods that corresponding ones of the voxels of the 3D image are abnormal.

Example 3 includes the apparatus of example 1 or example 2, wherein one or more of the at least one processor circuit is to identify a location of a first voxel of the 3D image, and identify one of the first values of the first 2D anomaly map corresponding to the location of the first voxel, identify one of the second values of the second 2D anomaly map corresponding to the location of the first voxel, and combine the one of the first values and the one of the second values to determine one of the third values of the 3D anomaly volume, the one of the third values corresponding to the location of the first voxel.

Example 4 includes the apparatus of any one of examples 1 to 3, wherein one or more of the at least one processor circuit is to average the one of the first values and the one of the second values to determine the one of the third values.

Example 5 includes the apparatus of any one of examples 1 to 4, wherein one or more of the at least one processor circuit is to generate the first 2D anomaly map based on a first machine learning model, and generate the second 2D anomaly map based on a second machine learning model different than the first machine learning model.

Example 6 includes the apparatus of any one of examples 1 to 5, wherein one or more of the at least one processor circuit is to obtain neural network features representative of the first 2D image slice, the neural network features corresponding to an output of a layer of a neural network obtained based on application of the first 2D image slice to an input of the neural network, generate a reduced dimensionality embedding corresponding to the neural network features, the reduced dimensionality embedding based on a trained principal component analysis (PCA) model, and generate the first 2D anomaly map based on a difference between the first 2D image slice and a reconstructed image slice, the reconstructed image slice based on the reduced dimensionality embedding.

Example 7 includes the apparatus of any one of examples 1 to 6, wherein one or more of the at least one processor circuit is to obtain the neural network features via a network from a remote device.

Example 8 includes the apparatus of any one of examples 1 to 7, wherein one or more of the at least one processor circuit is to generate a first plurality of two-dimensional (2D) anomaly maps corresponding respectively to a first plurality of 2D image slices of the 3D image, the first plurality of 2D image slices along the first axis of the 3D image, the first plurality of 2D image slices including the first 2D image slice, the first plurality of 2D anomaly maps including the first 2D anomaly map, and generate a second plurality of 2D anomaly maps corresponding respectively to a second plurality of 2D image slices of the 3D image, the second plurality of 2D image slices along the second axis of the 3D image, the second plurality of 2D image slices including the second 2D image slice, the second plurality of 2D anomaly maps including the second 2D anomaly map, wherein the 3D anomaly volume is based on a combination of the first plurality of 2D anomaly maps and the second plurality of 2D anomaly maps.

Example 9 includes the apparatus of any one of examples 1 to 8, wherein the first plurality of 2D image slices includes a first block of 2D image slices and a second block of 2D image slices, the first plurality of 2D anomaly maps includes a first block of 2D anomaly maps and a second block of 2D anomaly maps, the first block of 2D anomaly maps corresponds respectively to the first block of 2D image slices and the second block of 2D anomaly maps corresponds respectively to the second block of 2D image slices, and one or more of the at least one processor circuit is to generate the first block of 2D anomaly maps based on a first machine learning model, generate the second block of 2D anomaly maps based on a second machine learning model different than the first machine learning model, concatenate the first block of 2D anomaly maps to generate a first 3D block-level anomaly sub-volume corresponding respectively to a first 3D sub-volume of the 3D image, and concatenate the second block of 2D anomaly maps to generate a second 3D block-level anomaly sub-volume corresponding respectively to a second 3D sub-volume of the 3D image.

Example 10 includes the apparatus of any one of examples 1 to 9, wherein the 3D anomaly volume is an output 3D anomaly volume corresponding to the 3D image, and to generate the output 3D anomaly volume, one or more of the at least one processor circuit is to concatenate the first plurality of 2D anomaly maps to generate a first 3D anomaly volume, concatenate the second plurality of 2D anomaly maps to generate a second 3D anomaly volume, and rotate the second 3D anomaly volume based on a relationship between the first axis and the second axis of the 3D image, and determine values at respective locations of the output 3D anomaly volume based on averages of corresponding values of at least the first 3D anomaly volume and the rotated second 3D anomaly volume at the respective locations.

Example 11 includes at least one non-transitory computer readable medium comprising computer readable instructions to cause at least one processor circuitry to at least generate a first two-dimensional (2D) anomaly map corresponding to a first 2D image slice of a 3D image, the first 2D image slice corresponding to a first axis of the 3D image, generate a second 2D anomaly map corresponding to a second 2D image slice of the 3D image, the second 2D image slice corresponding to a second axis of the 3D image, and generate a 3D anomaly volume based on the first 2D anomaly map and the second 2D anomaly map, the 3D anomaly volume corresponding to the 3D image.

Example 12 includes the at least one non-transitory computer readable medium of example 11, wherein the computer readable instructions are to cause one or more of the at least one processor circuit to generate the first 2D anomaly map based on a first machine learning model, and generate the second 2D anomaly map based on a second machine learning model different than the first machine learning model.

Example 13 includes the at least one non-transitory computer readable medium of example 11 or example 12, wherein the computer readable instructions are to cause one or more of the at least one processor circuit to obtain neural network features representative of the first 2D image slice, the neural network features corresponding to an output of a layer of a neural network obtained based on application of the first 2D image slice to an input of the neural network, generate a reduced dimensionality embedding corresponding to the neural network features, the reduced dimensionality embedding based on a trained principal component analysis (PCA) model, and generate the first 2D anomaly map based on a difference between the first 2D image slice and a reconstructed image slice, the reconstructed image slice based on the reduced dimensionality embedding.

Example 14 includes the at least one non-transitory computer readable medium of any one of examples 11 to 13, wherein the computer readable instructions are to cause one or more of the at least one processor circuit to generate first blocks of two-dimensional (2D) anomaly maps corresponding respectively to first blocks of 2D image slices of the 3D image, the first blocks of 2D image slices along the first axis of the 3D image, one of the first blocks of 2D image slices including the first 2D image slice, a corresponding one of the first blocks of 2D anomaly maps including the first 2D anomaly map, generate second blocks of 2D anomaly maps corresponding respectively to second blocks of 2D image slices of the 3D image, the second blocks of 2D image slices along the second axis of the 3D image, one of the second blocks of 2D image slices including the second 2D image slice, a corresponding one of the second blocks of 2D anomaly maps including the second 2D anomaly map, concatenate the 2D anomaly maps in respective ones of the first blocks of 2D anomaly maps to generate respective first 3D block-level anomaly sub-volumes corresponding to respective first 3D sub-volumes of the 3D image, and concatenate the 2D anomaly maps in respective ones of the second blocks of 2D anomaly maps to generate respective second 3D block-level anomaly sub-volumes corresponding to respective second 3D sub-volumes of the 3D image.

Example 15 includes the at least one non-transitory computer readable medium of any one of examples 11 to 14, wherein the 3D anomaly volume is an output 3D anomaly volume corresponding to the 3D image, and to generate the output 3D anomaly volume, the computer readable instructions are to cause one or more of the at least one processor circuit to concatenate the first 3D block-level anomaly sub-volumes to generate a first 3D anomaly volume, concatenate the second 3D block-level anomaly sub-volumes to generate a second 3D anomaly volume, and rotate the second 3D anomaly volume based on a relationship between the first axis and the second axis of the 3D image, and determine values at respective locations of the output 3D anomaly volume based on averages of corresponding values of at least the first 3D anomaly volume and the rotated second 3D anomaly volume at the respective locations.

Example 16 includes a method to detect an anomaly in a three-dimensional (3D) image, the method comprising generating a first two-dimensional (2D) anomaly map corresponding to a first 2D image slice of the 3D image, the first 2D image slice corresponding to a first axis of the 3D image, generating a second 2D anomaly map corresponding to a second 2D image slice of the 3D image, the second 2D image slice corresponding to a second axis of the 3D image, and generating, by at least one processor circuit programed by at least one instruction, a 3D anomaly volume based on the first 2D anomaly map and the second 2D anomaly map, the 3D anomaly volume corresponding to the 3D image.

Example 17 includes the method of example 16, wherein the generating of the first 2D anomaly map is based on a first machine learning model, and the generating of the second 2D anomaly map is based on a second machine learning model different than the first machine learning model.

Example 18 includes the method of example 16 or example 17, wherein the generating of the first 2D anomaly map includes obtaining neural network features representative of the first 2D image slice, the neural network features corresponding to an output of a layer of a neural network obtained based on application of the first 2D image slice to an input of the neural network, generating a reduced dimensionality embedding corresponding to the neural network features, the reduced dimensionality embedding based on a trained principal component analysis (PCA) model, and generating the first 2D anomaly map based on a difference between the first 2D image slice and a reconstructed image slice, the reconstructed image slice based on the reduced dimensionality embedding.

Example 19 includes the method of any one of examples 16 to 18, including generating first blocks of two-dimensional (2D) anomaly maps corresponding respectively to first blocks of 2D image slices of the 3D image, the first blocks of 2D image slices along the first axis of the 3D image, one of the first blocks of 2D image slices including the first 2D image slice, a corresponding one of the first blocks of 2D anomaly maps including the first 2D anomaly map, generating second blocks of 2D anomaly maps corresponding respectively to second blocks of 2D image slices of the 3D image, the second blocks of 2D image slices along the second axis of the 3D image, one of the second blocks of 2D image slices including the second 2D image slice, a corresponding one the second blocks of 2D anomaly maps including the second 2D anomaly map, concatenating the 2D anomaly maps in respective ones of the first blocks of 2D anomaly maps to generate respective first 3D block-level anomaly sub-volumes corresponding to respective first 3D sub-volumes of the 3D image, and concatenating the 2D anomaly maps in respective ones of the second blocks of 2D anomaly maps to generate respective second 3D block-level anomaly sub-volumes corresponding to respective second 3D sub-volumes of the 3D image.

Example 20 includes the method of any one of examples 16 to 19, wherein the 3D anomaly volume is an output 3D anomaly volume corresponding to the 3D image, and the generating of the output 3D anomaly volume includes concatenating the first 3D block-level anomaly sub-volumes to generate a first 3D anomaly volume, concatenating the second 3D block-level anomaly sub-volumes to generate a second 3D anomaly volume, and rotating the second 3D anomaly volume based on a relationship between the first axis and the second axis of the 3D image, and determining values at respective locations of the output 3D anomaly volume based on averages of corresponding values of at least the first 3D anomaly volume and the rotated second 3D anomaly volume at the respective locations.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to detect an anomaly in a three-dimensional (3D) image, the apparatus comprising:
interface circuitry;
computer readable instructions; and
at least one processor circuit to be programmed by the computer readable instructions to:
generate a first two-dimensional (2D) anomaly map corresponding to a first 2D image slice of the 3D image, the first 2D image slice corresponding to a first axis of the 3D image;
generate a second 2D anomaly map corresponding to a second 2D image slice of the 3D image, the second 2D image slice corresponding to a second axis of the 3D image; and
generate a 3D anomaly volume based on the first 2D anomaly map and the second 2D anomaly map, the 3D anomaly volume corresponding to the 3D image.

2. The apparatus of claim 1, wherein:
the first 2D anomaly map includes first values corresponding respectively to pixels of the first 2D image slice, the first values to represent respective likelihoods that corresponding ones of the pixels of the first 2D image slice are abnormal;
the second 2D anomaly map includes second values corresponding respectively to pixels of the second 2D image slice, the second values to represent respective likelihoods that corresponding ones of the pixels of the second 2D image slice are abnormal; and
the 3D anomaly volume includes third values corresponding respectively to voxels of the 3D image, the third values to represent respective likelihoods that corresponding ones of the voxels of the 3D image are abnormal.

3. The apparatus of claim 2, wherein one or more of the at least one processor circuit is to:
identify a location of a first voxel of the 3D image; and
identify one of the first values of the first 2D anomaly map corresponding to the location of the first voxel;
identify one of the second values of the second 2D anomaly map corresponding to the location of the first voxel; and
combine the one of the first values and the one of the second values to determine one of the third values of the 3D anomaly volume, the one of the third values corresponding to the location of the first voxel.

4. The apparatus of claim 3, wherein one or more of the at least one processor circuit is to average the one of the first values and the one of the second values to determine the one of the third values.

5. The apparatus of claim 1, wherein one or more of the at least one processor circuit is to:
generate the first 2D anomaly map based on a first machine learning model; and
generate the second 2D anomaly map based on a second machine learning model different than the first machine learning model.

6. The apparatus of claim 1, wherein one or more of the at least one processor circuit is to:
obtain neural network features representative of the first 2D image slice, the neural network features corresponding to an output of a layer of a neural network obtained based on application of the first 2D image slice to an input of the neural network;
generate a reduced dimensionality embedding corresponding to the neural network features, the reduced dimensionality embedding based on a trained principal component analysis (PCA) model; and
generate the first 2D anomaly map based on a difference between the first 2D image slice and a reconstructed image slice, the reconstructed image slice based on the reduced dimensionality embedding.

7. The apparatus of claim 6, wherein one or more of the at least one processor circuit is to obtain the neural network features via a network from a remote device.

8. The apparatus of claim 1, wherein one or more of the at least one processor circuit is to:
generate a first plurality of two-dimensional (2D) anomaly maps corresponding respectively to a first plurality of 2D image slices of the 3D image, the first plurality of 2D image slices along the first axis of the 3D image, the first plurality of 2D image slices including the first 2D image slice, the first plurality of 2D anomaly maps including the first 2D anomaly map; and
generate a second plurality of 2D anomaly maps corresponding respectively to a second plurality of 2D image slices of the 3D image, the second plurality of 2D image slices along the second axis of the 3D image, the second plurality of 2D image slices including the second 2D image slice, the second plurality of 2D anomaly maps including the second 2D anomaly map, wherein the 3D anomaly volume is based on a combination of the first plurality of 2D anomaly maps and the second plurality of 2D anomaly maps.

9. The apparatus of claim 8, wherein the first plurality of 2D image slices includes a first block of 2D image slices and a second block of 2D image slices, the first plurality of 2D anomaly maps includes a first block of 2D anomaly maps and a second block of 2D anomaly maps, the first block of 2D anomaly maps corresponds respectively to the first block of 2D image slices and the second block of 2D anomaly maps corresponds respectively to the second block of 2D image slices, and one or more of the at least one processor circuit is to:
generate the first block of 2D anomaly maps based on a first machine learning model;
generate the second block of 2D anomaly maps based on a second machine learning model different than the first machine learning model;
concatenate the first block of 2D anomaly maps to generate a first 3D block-level anomaly sub-volume corresponding respectively to a first 3D sub-volume of the 3D image; and
concatenate the second block of 2D anomaly maps to generate a second 3D block-level anomaly sub-volume corresponding respectively to a second 3D sub-volume of the 3D image.

10. The apparatus of claim 8, wherein the 3D anomaly volume is an output 3D anomaly volume corresponding to the 3D image, and to generate the output 3D anomaly volume, one or more of the at least one processor circuit is to:
concatenate the first plurality of 2D anomaly maps to generate a first 3D anomaly volume;
concatenate the second plurality of 2D anomaly maps to generate a second 3D anomaly volume; and
rotate the second 3D anomaly volume based on a relationship between the first axis and the second axis of the 3D image; and
determine values at respective locations of the output 3D anomaly volume based on averages of corresponding values of at least the first 3D anomaly volume and the rotated second 3D anomaly volume at the respective locations.

11. At least one non-transitory computer readable medium comprising computer readable instructions to cause at least one processor circuitry to at least:
generate a first two-dimensional (2D) anomaly map corresponding to a first 2D image slice of a 3D image, the first 2D image slice corresponding to a first axis of the 3D image;
generate a second 2D anomaly map corresponding to a second 2D image slice of the 3D image, the second 2D image slice corresponding to a second axis of the 3D image; and
generate a 3D anomaly volume based on the first 2D anomaly map and the second 2D anomaly map, the 3D anomaly volume corresponding to the 3D image.

12. The at least one non-transitory computer readable medium of claim 11, wherein the computer readable instructions are to cause one or more of the at least one processor circuit to:
generate the first 2D anomaly map based on a first machine learning model; and
generate the second 2D anomaly map based on a second machine learning model different than the first machine learning model.

13. The at least one non-transitory computer readable medium of claim 11, wherein the computer readable instructions are to cause one or more of the at least one processor circuit to:
obtain neural network features representative of the first 2D image slice, the neural network features corresponding to an output of a layer of a neural network obtained based on application of the first 2D image slice to an input of the neural network;
generate a reduced dimensionality embedding corresponding to the neural network features, the reduced dimensionality embedding based on a trained principal component analysis (PCA) model; and
generate the first 2D anomaly map based on a difference between the first 2D image slice and a reconstructed image slice, the reconstructed image slice based on the reduced dimensionality embedding.

14. The at least one non-transitory computer readable medium of claim 11, wherein the computer readable instructions are to cause one or more of the at least one processor circuit to:
generate first blocks of two-dimensional (2D) anomaly maps corresponding respectively to first blocks of 2D image slices of the 3D image, the first blocks of 2D image slices along the first axis of the 3D image, one of the first blocks of 2D image slices including the first 2D image slice, a corresponding one of the first blocks of 2D anomaly maps including the first 2D anomaly map;
generate second blocks of 2D anomaly maps corresponding respectively to second blocks of 2D image slices of the 3D image, the second blocks of 2D image slices along the second axis of the 3D image, one of the second blocks of 2D image slices including the second 2D image slice, a corresponding one of the second blocks of 2D anomaly maps including the second 2D anomaly map;
concatenate the 2D anomaly maps in respective ones of the first blocks of 2D anomaly maps to generate respective first 3D block-level anomaly sub-volumes corresponding to respective first 3D sub-volumes of the 3D image; and
concatenate the 2D anomaly maps in respective ones of the second blocks of 2D anomaly maps to generate respective second 3D block-level anomaly sub-volumes corresponding to respective second 3D sub-volumes of the 3D image.

15. The at least one non-transitory computer readable medium of claim 14, wherein the 3D anomaly volume is an output 3D anomaly volume corresponding to the 3D image, and to generate the output 3D anomaly volume, the computer readable instructions are to cause one or more of the at least one processor circuit to:
concatenate the first 3D block-level anomaly sub-volumes to generate a first 3D anomaly volume;
concatenate the second 3D block-level anomaly sub-volumes to generate a second 3D anomaly volume; and
rotate the second 3D anomaly volume based on a relationship between the first axis and the second axis of the 3D image; and
determine values at respective locations of the output 3D anomaly volume based on averages of corresponding values of at least the first 3D anomaly volume and the rotated second 3D anomaly volume at the respective locations.

16. A method to detect an anomaly in a three-dimensional (3D) image, the method comprising:
generating a first two-dimensional (2D) anomaly map corresponding to a first 2D image slice of the 3D image, the first 2D image slice corresponding to a first axis of the 3D image;
generating a second 2D anomaly map corresponding to a second 2D image slice of the 3D image, the second 2D image slice corresponding to a second axis of the 3D image; and
generating, by at least one processor circuit programed by at least one instruction, a 3D anomaly volume based on the first 2D anomaly map and the second 2D anomaly map, the 3D anomaly volume corresponding to the 3D image.

17. The method of claim 16, wherein the generating of the first 2D anomaly map is based on a first machine learning model, and the generating of the second 2D anomaly map is based on a second machine learning model different than the first machine learning model.

18. The method of claim 16, wherein the generating of the first 2D anomaly map includes:
obtaining neural network features representative of the first 2D image slice, the neural network features corresponding to an output of a layer of a neural network obtained based on application of the first 2D image slice to an input of the neural network;
generating a reduced dimensionality embedding corresponding to the neural network features, the reduced dimensionality embedding based on a trained principal component analysis (PCA) model; and
generating the first 2D anomaly map based on a difference between the first 2D image slice and a reconstructed image slice, the reconstructed image slice based on the reduced dimensionality embedding.

19. The method of claim 16, including:
generating first blocks of two-dimensional (2D) anomaly maps corresponding respectively to first blocks of 2D image slices of the 3D image, the first blocks of 2D image slices along the first axis of the 3D image, one of the first blocks of 2D image slices including the first 2D image slice, a corresponding one of the first blocks of 2D anomaly maps including the first 2D anomaly map;
generating second blocks of 2D anomaly maps corresponding respectively to second blocks of 2D image slices of the 3D image, the second blocks of 2D image slices along the second axis of the 3D image, one of the second blocks of 2D image slices including the second 2D image slice, a corresponding one the second blocks of 2D anomaly maps including the second 2D anomaly map;
concatenating the 2D anomaly maps in respective ones of the first blocks of 2D anomaly maps to generate respective first 3D block-level anomaly sub-volumes corresponding to respective first 3D sub-volumes of the 3D image; and
concatenating the 2D anomaly maps in respective ones of the second blocks of 2D anomaly maps to generate respective second 3D block-level anomaly sub-volumes corresponding to respective second 3D sub-volumes of the 3D image.

20. The method of claim 19, wherein the 3D anomaly volume is an output 3D anomaly volume corresponding to the 3D image, and the generating of the output 3D anomaly volume includes:
concatenating the first 3D block-level anomaly sub-volumes to generate a first 3D anomaly volume;
concatenating the second 3D block-level anomaly sub-volumes to generate a second 3D anomaly volume; and
rotating the second 3D anomaly volume based on a relationship between the first axis and the second axis of the 3D image; and
determining values at respective locations of the output 3D anomaly volume based on averages of corresponding values of at least the first 3D anomaly volume and the rotated second 3D anomaly volume at the respective locations.
